(19) United States
(12) Patent Application Publication
(10) Pub. No.: US 2006/0126216 A1
(43) Pub. Date: Jun. 15, 2006

(54) Annular shroud for a rotating disc

(76) Inventors: Jason A. Sorrell, Aurora, CO (US); Robert A. Alt, Longmont, CO (US)

Correspondence Address: Jennifer M. Buenzow;Seagate Technology LLC, Intellectual Property Dept. -SHK2LG, 1280 Disc Drive, Shakopee, MN, 55379-1863, US

(21) Appl. No.: 11/011,908

(22) Filed: Dec. 14, 2004

(51) Int. Cl. G11B 17/00

(52) U.S. Cl. 360/97.01

(57) ABSTRACT

An enclosure is provided defining an annular shroud adapted for receivingly engaging a rotatable data storage media. A method is provided for managing fluid flow created by a moving data storage medium, the method comprising circumscribing an annular shroud adjacent to an edge of the medium. A data storage device is provided comprising a rotatable data storage disc, and a fluid flow conditioner for minimizing excitation imparted to the disc by steps for managing fluid flow surrounding the disc.

### FIELD OF THE INVENTION

The embodiments of the present invention relate generally to the field of data storage systems and more particularly without limitation to windage management for reducing fluid flow excitation of rotating components.

### BACKGROUND

Modern data storage devices such as disc drives are commonly used in a multitude of computer environments to store large amounts of data in a form that is readily available to a user. Generally, a disc drive has a magnetic disc, or two or more stacked magnetic discs, that are rotated by a motor at high speeds. Each disc has a data storage surface divided into data tracks where data is stored in the form of magnetic flux transitions.

A data transfer member such as a magnetic transducer is moved by an actuator to selected positions adjacent the data storage surface to sense the magnetic flux transitions in reading data from the disc, and to transmit electrical signals to induce the magnetic flux transitions in writing data to the disc. The active elements of the data transfer member are supported by suspension structures extending from the actuator. The active elements are maintained a small distance from the data storage surface by a fluid bearing generated by fluid currents caused by the spinning discs. The term “fluid bearing” is synonymous with the widely used term “air bearing” where the fluid utilized in the disc drive is air. Alternatively, the term “fluid bearing” is applicable to other embodiments utilizing a fluid other than air, such as helium.

A continuing trend in the data storage industry is toward ever-increasing the data storage capacity and the processing speed while maintaining or reducing the physical size of the disc drive. Consequently, the data transfer member and the supporting structures are continually being miniaturized, and data storage densities are continually being increased. One result is an overall increased sensitivity to vibration as a percentage of track width.

One source of vibration comes from the fluid currents, or windage, that is created by the spinning discs. Fluid flow perturbations, and especially turbulent fluid flow, can excite the actuator and/or the disc creating vibrations. Such vibrations can create actuator positional control errors, resulting in data reading and writing errors.

While various proposed solutions have been found operable, there remains a continued need for improvements in windage management for attenuating excitation energy. It is to such improvements that the claimed invention is generally directed.

### SUMMARY OF THE INVENTION

In accordance with preferred embodiments, an apparatus and method are provided for managing windage for attenuating excitation energy in a data storage device.

In some embodiments an enclosure is provided defining an annular shroud adapted for receivingly engaging a rotatable data storage media.

In other embodiments a method is provided for managing fluid flow created by a moving data storage medium, the method comprising circumscribing an annular shroud adjacent to an edge of the medium.

In other embodiments a data storage device is provided comprising a rotatable data storage disc, and a fluid flow conditioner for minimizing excitation imparted to the disc by steps for managing fluid flow surrounding the disc.

These and various other features and advantages which characterize the claimed invention will become apparent upon reading the following detailed description and upon reviewing the associated drawings.

### BRIEF DESCRIPTION OF THE DRAWINGS

FIG. 1 is an isometric view of a data storage device constructed in accordance with embodiments of the present invention.

FIG. 2 is an isometric view of the base portion of the data storage device in FIG. 1.

FIG. 3 is a cross sectional view taken along the line 3-3 of FIG. 1.

FIG. 4 is an enlarged detail of a portion of FIG. 3.

FIGS. 5 and 6 are views similar to FIG. 4 but constructed in accordance with alternative embodiments of the present invention.

FIG. 7 is a flowchart illustrating steps for practicing a method in accordance with embodiments of the present invention.

FIG. 8 is a view similar to FIG. 3 but constructed in accordance with alternative embodiments of the present invention.

FIG. 9 is graphical data illustrating measured vibration attenuation resulting from practicing embodiments of the present invention.

### DETAILED DESCRIPTION

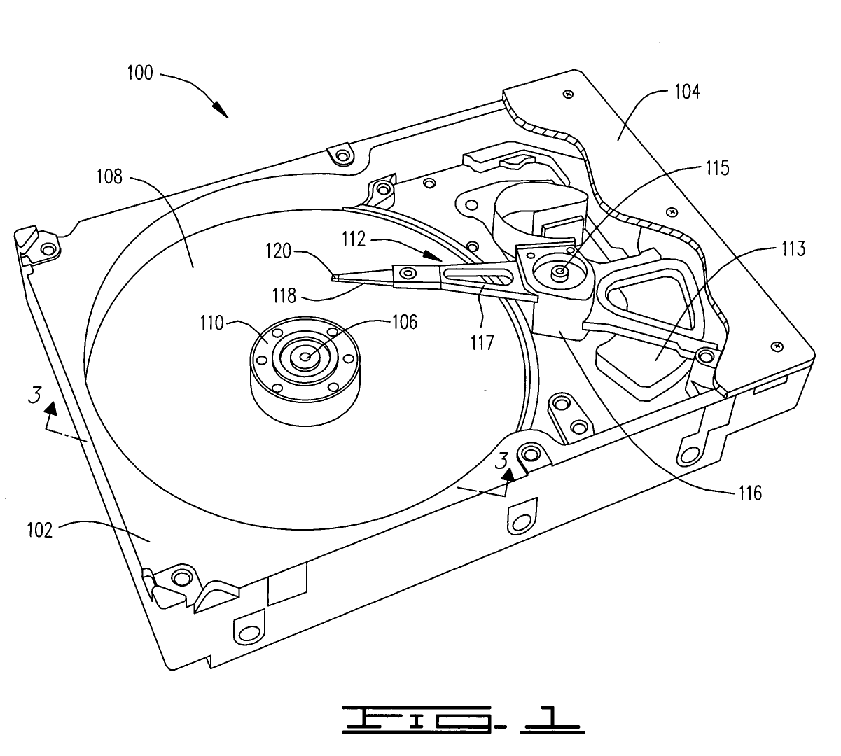

Referring to the drawings in general, and more particularly to FIG. 1, shown therein is a data storage device 100 that is constructed in accordance with embodiments of the present invention. The data storage device 100 includes a base 102 to which various disc drive components are mounted, and a cover 104 (partially cutaway) which together with the base 102 and a perimeter gasket form an enclosure providing a sealed internal environment for the data storage device 100.

Mounted to the base 102 is a motor 106 to which a disc 108 is secured by a clamp ring 110 for rotation at a high speed. An actuator 112 pivots around a pivot bearing 115, as directed by a voice coil motor 113, in a plane parallel to the discs 108. The actuator 112 has a moveable block 116, sometimes referred to as an “e-block,” and a cantilevered arm 117 extending therefrom. Note that in some embodiments the actuator 112 can have only one arm 117, while in equivalent alternative embodiments the actuator 112 can have more than one arm 117.

The arm 117 supports a load arm 118 in travel across the disc 108. The load arm 118 is a flex member that supports a data transfer member, such as data head 120, in operationally interfacing a surface of one of the discs 108 in a data reading and writing relationship. This relationship is maintained by a slider (not shown) which operably supports the head 120 on a fluid bearing sustained by fluid currents generated by the spinning discs 108. In some embodiments the fluid can be air; in other embodiments the fluid can be something other than air such as but not limited to helium.

The kinetic energy of the spinning disc 108 is transferred by friction to the fluid at the disc/fluid boundary layer, thereby imparting a force vector to the fluid. The combined rotational and centrifugal forces from the spinning disc 108 create a generally outwardly spiraling fluid flow pattern to the fluid surrounding the disc 108. By practicing embodiments of the present invention, this fluid flow, or windage, can be managed so as to attenuate excitation energy on the disc 108 to a level below an acceptable threshold level.

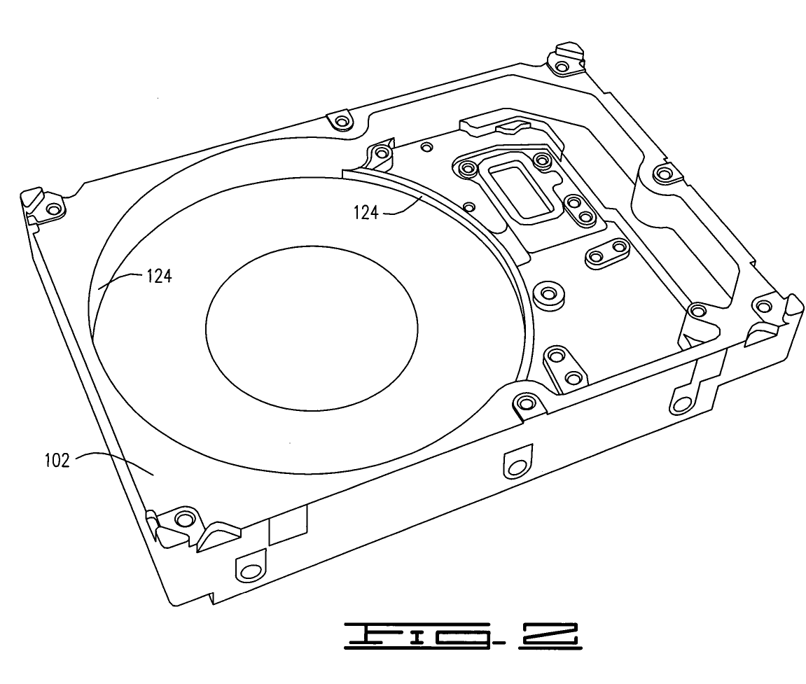

FIG. 2 is a view of the base 102 with the disc 108 and actuator 112 removed. The base 102 defines an annular surface 124 (sometimes referred to herein as “shroud” 124) that is adapted for receivingly engaging the disc 108. For purposes of this description and the appended claims, “annular” means that the shroud substantially circumscribes the disc 108. In other words, the annular shroud 124 completely surrounds the disc 108. That is, there is no gap in the annular surface 124 that would serve to disrupt the airflow conditioning aspects of the shroud 124.

Such gaps in a shroud, not present herein, are commonly associated with functional aspects of the data storage device. For example, there is a gap commonly provided in other solutions for radial movement of the actuator. In still other solutions there is a gap commonly provided for directing windage away from the disc 108. The embodiments of the present invention are directed away from such solutions so as to achieve the benefits of a disc edge damper, discussed below, placed completely around the disc.

As best shown in FIG. 3, the base 102 further defines a planar surface 126 intersecting the shroud 124 and thereby forming a cylindrical cavity 128 for receivingly engaging the disc 108. In the embodiments of FIGS. 2 and 3, the base 102 is unitarily formed as a single component. Accordingly, in these preferred embodiments the shroud 124 and the planar surface 126 comprise a unitary closed-ended cylindrical surface, such as can be provided by molding, casting or machining the features in the base 102. Alternatively, discrete component members can be joined to the base 102 to completely or partially form the annular surface 124 and/or the planar surface 126.

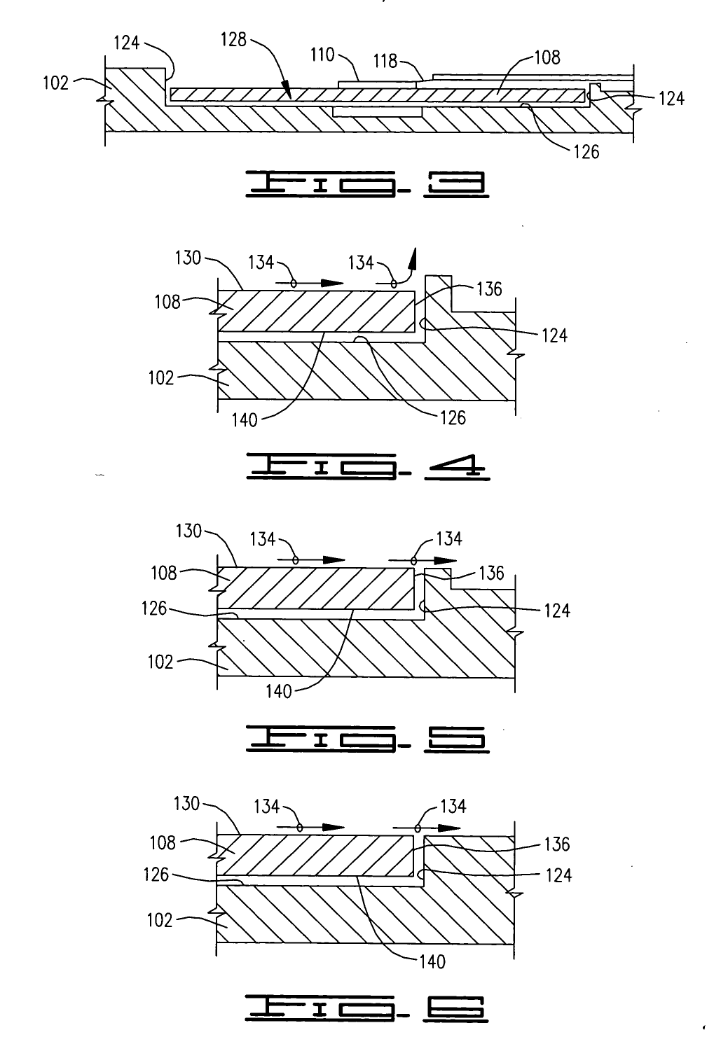

FIG. 4 is an enlarged detail of the actuator 112 side portion of FIG. 3, wherein the shroud 124 extends beyond a surface 130 of the disc 108. This arrangement imparts a tangential force on the outwardly spiraling airflow, designated as windage 134. Preferably, the shroud 124 can be sized in relation to the disc 108 to provide a close mating relationship with an edge 136 of the disc 108. By sizing the annular shroud 124 for a close mating relationship with the edge 136, then the shroud 124 acts as a disc edge damper effectively directing the windage 134 without creating eddy currents acting on the disc 108. Advantageously, it has been determined that the clearance between the edge 136 and the shroud 124 can be less than about 0.020 inches.

Further, by mounting the disc 108 in the cavity 128 so as to provide a close mating relationship with an opposing side 140 of the disc 108 and the planar surface 126, then the planar surface 126 acts as a windage stripper effectively minimizing the magnitude of turbulent airflow adjacent to the disc 108. Advantageously, it has been determined that the clearance between the side 140 and the planar surface 126 can be less than 0.020 inches.

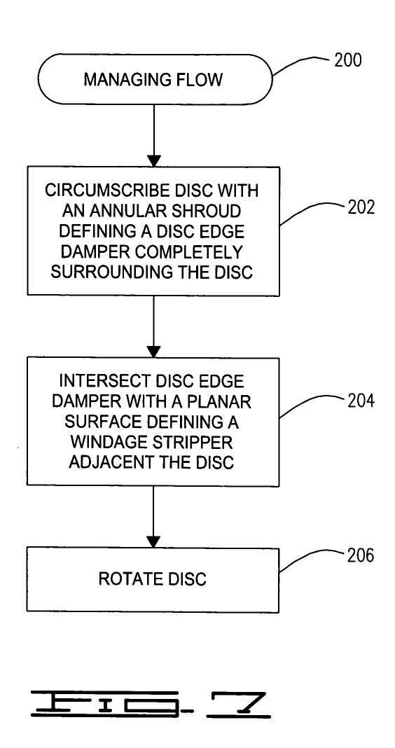

FIGS. 5 and 6 illustrate equivalent alternative embodiments wherein the shroud 124 extends so as to be substantially flush with the surface 130 of the disc 108. As noted by the windage 134, this arrangement provides for directing the outwardly spiraling windage 134 away from the disc 108. By providing the close mating relationship between the edge 136 and the shroud 124, as above, the shroud 124 acts as a disc edge damper preventing shedding vortices from exciting the disc 108. Advantageously, the arrangement of FIG. 4 can be provided circumferentially around the disc 108 to channel the windage 134 to a location of the shroud 124 whereat the arrangement of FIG. 5 or 6 exists to channel the windage 134 away from the disc 108. This permits channeling the outwardly flowing windage 134 in a particular direction, such as without limitation for directing the windage 134 toward a filter (not shown) or toward a component, such as the voice coil motor 113 (FIG. 1), for cooling purposes.

Generally, it will be appreciated that the embodiments of the present invention contemplate an enclosure defining an annular shroud 124 surrounding the rotatable disc 108. Particularly, there is no opening provided in the shroud 124 through which the actuator 112 passes in accessing the disc 108. Furthermore, the clearance between the shroud 124 and the disc edge 136 is preferably minimized in order to achieve the greatest disc edge damper benefits of this arrangement. However, this minimal disc edge 136 to shroud 124 clearance may run counter to a desired use of a push tool during the assembly process to bias the disc 108 with respect to the centrally supporting motor 106. In some embodiments, therefore, it can be advantageous to provide a clearance notch or opening into or through the shroud 124 for the purpose of inserting the push tool. If so, it has been determined that the size of such a notch or opening that is suited for this purpose can be less than about 0.100 inches wide.

FIG. 7 is a flow chart of a method 200 for MANAGING FLUID FLOW that illustrates steps for practicing embodiments of the present invention. The method 200 comprises in block 202 circumscribing the disc 108 with the annular shroud 124 so as to define a disc edge damper completely surrounding the disc 108. The method further comprises in block 204 intersecting the disc edge damper with the planar surface 126 defining a windage stripper adjacent the disc 108. In block 206 the disc 108 is rotated.

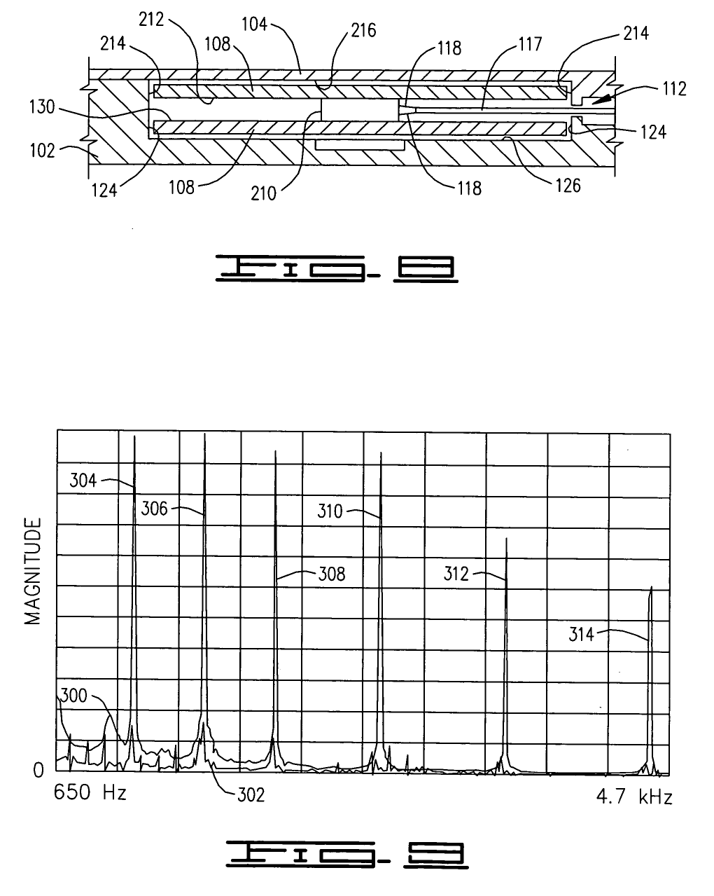

The embodiments discussed heretofore contemplate the use of a single disc 108 with the actuator 112 in an operable data reading and writing relationship with only the side 130 of the disc 108. FIG. 8 is illustrative of alternative equivalent embodiments utilized in conjunction with a disc stack of two or more discs 108 that are separated by spacers 210. Although the illustrative embodiments of FIG. 8 involve two discs 108, the principles are duplicative for more than two discs 108, and as such a full enumeration of all possible disc stack configurations is not necessary for a skilled artisan to understand the contemplated scope of the embodiments of the present invention.

In FIG. 8 the actuator 112 is in an operable data reading and writing relationship both with side 130 of one disc 108 and with a side 212 of the other disc 108. In some embodiments, only one disc 108 is acted upon by the disc edge damper provided by the annular shroud 124 and the windage stripper provided by the planar surface 126. Alternatively, as shown in FIG. 8, the other disc 108 can also be acted upon in a like manner by the cover 104 defining a disc edge damper by an annular surface 214, and defining a windage stripper by a planar surface 216. In other embodiments (not shown) one or more additional discs 108 can be interposed between the outside discs 108 that are enclosed within the annular shroud 124.

FIG. 9 is a plot illustrating a measured reduction in windage excitation resulting from practicing the embodiments of the present invention. In the plot, graphical line 300 is the measured frequency domain response for vibration of a disc in a data storage device having a partial shroud, such as with a clearance opening for movement of the actuator. Graphical line 302 is the measured frequency domain response for vibration of a disc in a data storage device constructed in accordance with embodiments of the present invention. It will be noted from a comparison of the graphical lines 300, 302 that a number of sharp vibration spikes 304, 306, 308, 310, 312, 314 were effectively attenuated.

Summarizing generally, embodiments of the present invention contemplate an enclosure (such as 102, 104) defining an annular shroud (such as 124) adapted for receivingly engaging a rotatable data storage media (such as 108). In some embodiments the shroud comprises a unitary arcuate surface. The enclosure can further comprise a planar surface (such as 126) intersecting the annular shroud defining a cylindrical cavity (such as 128). In some embodiments the planar surface and the annular shroud are unitarily constructed.

The cylindrical cavity is adapted for receivingly engaging the media in a close mating relationship between the planar surface and a side of the media. In some embodiments the close mating relationship can be defined by a clearance between the planar surface and the media of less than about 0.020 inches. The cylindrical cavity can further be adapted for receivingly engaging the media in a close mating relationship between the annular shroud and an edge of the media. In some embodiments the close mating relationship can be defined by a clearance between the annular shroud and the edge of the disc less than about 0.020 inches. In some embodiments the enclosure defines an enclosure in a data storage device.

Embodiments of the present invention further contemplate a method (such as 200) for managing fluid flow (such as 134) created by the moving data storage medium. The method comprises circumscribing an annular shroud adjacent to an edge of the medium (such as 202), intersecting a planar surface with the arcuate surface (such as 204) defining the cylindrical cavity that is receivingly engageable with the medium, and rotating the medium (such as 206).

The circumscribing step can be characterized by a unitary arcuate surface. The circumscribing and intersecting steps can be characterized by a unitary planar surface and arcuate surface.

The method can further comprise receivingly engaging the medium in a close mating relationship between the planar surface and a side of the medium defining a windage stripper. In some embodiments the receivingly engaging step is characterized by the close mating relationship defining a clearance between the planar surface and the medium of less than about 0.020 inches.

The method can further comprise receivingly engaging the medium in a close mating relationship between the arcuate surface and the edge of the medium. In some embodiments the receivingly engaging step is characterized by the close mating relationship defining a clearance between the arcuate surface and the medium of less than about 0.020 inches.

Embodiments of the present invention further contemplate a data storage device comprising a rotatable data storage disc, and a fluid flow conditioner for minimizing excitation imparted to the disc by steps for managing fluid flow surrounding the disc. In some embodiments the steps for managing fluid flow comprise circumscribing an annular shroud around the disc.

It is to be understood that even though numerous characteristics and advantages of various embodiments of the present invention have been set forth in the foregoing description, together with the details of the structure and function of various embodiments of the invention, this disclosure is illustrative only, and changes may be made in detail, especially in matters of structure and arrangement of parts within the principles of the present invention to the full extent indicated by the broad general meaning of the terms in which the appended claims are expressed. For example, the particular elements may vary depending on the extent to which the shroud is used to channel the outwardly moving windage 134 without departing from the scope and spirit of the present invention. In addition, although the preferred embodiments described herein are directed to a data writing device, it will be appreciated by those skilled in the art that the teachings of the present invention can be applied to other systems without departing from the spirit and scope of the present invention.

It will be clear that the present invention is well adapted to attain the ends and advantages mentioned as well as those inherent therein. While presently preferred embodiments have been described for purposes of this disclosure, numerous changes may be made which readily suggest themselves to those skilled in the art and which are encompassed in the spirit of the invention disclosed and as defined in the appended claims.

What is claimed is:

1. An enclosure for a data storage device defining an annular shroud adapted for receivingly engaging a rotatable data storage media.

2. The enclosure of claim 1 wherein the shroud comprises a unitary arcuate surface.

3. The enclosure of claim 1 comprising a planar surface intersecting the annular shroud defining a cylindrical cavity.

4. The enclosure of claim 3 wherein the planar surface and the annular shroud are unitarily constructed.

5. The enclosure of claim 3 wherein the cavity is adapted for receivingly engaging the media in a close mating relationship between the planar surface and a side of the media.

6. The enclosure of claim 5 wherein the close mating relationship is defined by a clearance between the planar surface and the media of less than about 0.020 inches.

7. The enclosure of claim 3 wherein the cavity is adapted for receivingly engaging the media in a close mating relationship between the annular shroud and an edge of the media.

8. The enclosure of claim 7 wherein the close mating relationship is defined by a clearance between the annular shroud and the edge of less than about 0.020 inches.

9. The enclosure of claim 1 defining a portion of an enclosure in a data storage device.

10. A method for managing fluid flow created by a moving data storage medium comprising circumscribing an annular shroud adjacent to an edge of the medium.

11. The method of claim 10 wherein the circumscribing step is characterized by a unitary arcuate surface.

12. The method of claim 10 comprising intersecting a planar surface with the arcuate surface defining a cylindrical cavity that is receivingly engageable with the medium.

13. The method of claim 12 wherein the circumscribing and intersecting steps are characterized by a unitary planar surface and arcuate surface.

14. The method of claim 12 comprising receivingly engaging the medium in a close mating relationship between the planar surface and a side of the medium.

15. The method of claim 14 wherein the receivingly engaging step is characterized by the close mating relationship defining a clearance between the planar surface and the medium of less than about 0.020 inches.

16. The method of claim 12 comprising recevingly engaging the medium in a close mating relationship between the arcuate surface and an edge of the medium.

17. The method of claim 16 wherein the receivingly engaging step is characterized by the close mating relationship defining a clearance between the arcuate surface and the medium of less than about 0.020 inches.

18. The method of claim 14 wherein the receivingly engaging step is characterized by the close mating relationship defining a clearance between the arcuate surface and the edge of the medium of less than about 0.020 inches.

19. A data storage device comprising:
a rotatable data storage disc; and
a fluid flow conditioner for minimizing excitation imparted to the disc by steps for managing fluid flow surrounding the disc.

20. The data storage device of claim 19 wherein the steps for managing fluid flow comprises circumscribing an annular shroud around the disc.
